(19) United States
(12) Patent Application Publication
(10) Pub. No.: US 2026/0109916 A1
(43) Pub. Date: Apr. 23, 2026

(54) ALKALINE CLEANING AGENT FOR ALUMINUM SURFACES

(71) Applicant: Henkel AG & Co. KGaA, Duesseldorf (DE)

(72) Inventors: Joerg Riesop, Kerpen (DE); Sarah Klaes, Duesseldorf (DE); Michal Manko, Duesseldorf (DE); Jessika Flender, Duesseldorf (DE)

(21) Appl. No.: 19/423,290

(22) Filed: Dec. 17, 2025

Related U.S. Application Data
(63) Continuation of application No. PCT/EP2024/067195, filed on Jun. 20, 2024.

(30) Foreign Application Priority Data
Jun. 29, 2023 (EP) 23182448.3

(51) Int. Cl. C11D 3/12; C11D 1/72; C11D 3/04; C11D 3/20

(52) U.S. Cl. CPC C11D 3/1233; C11D 1/721; C11D 3/04; C11D 3/2086

(57) ABSTRACT

The present invention relates to a method for cleaning and optionally degreasing aluminum surfaces, in particular during serial treatment of can cylinders made of aluminum, which provides a high degree of gloss, the method comprising contacting the aluminum surfaces with an alkaline cleaning agent containing, in addition to a builder and a surfactant, a quantity of at least one aluminate dissolved in water; the invention also relates to an alkaline cleaning agent as an application solution, which agent is especially suitable for use in a method according to the invention.

The present invention relates to a method for cleaning and optionally degreasing aluminum surfaces, in particular during serial treatment of can cylinders made of aluminum. In the method according to the invention, a high degree of gloss is achieved when using an alkaline cleaning agent containing, in addition to a builder and a surfactant, a quantity of at least one aluminate dissolved in water. The invention also relates to an alkaline cleaning agent as an application solution, which agent is especially suitable for being used in a method according to the invention.

When cleaning semi-finished products and components made of aluminum, good cleaning and degreasing of the surfaces can regularly be achieved and the cleaning agents used for this purpose are known in principle. However, a major problem is the reliable provision of high-gloss surfaces, especially in the series treatment of a plurality of semi-finished products/components. Especially with high component throughputs, changes in the composition of the cleaning bath due to consumption and the introduction of contaminants as well as inconsistent pickling or temporary over-pickling can mean that a high level of material waste has to be accepted or that components have to undergo a cleaning step several times. This is particularly problematic in can manufacturing, a highly standardized and automated production process with extreme throughput rates of several hundreds to several thousands of cans per minute. In addition, with regard to the use of decorative transparent outer can lacquers when producing cans, cans with low or inconsistent degrees of gloss are not perceived to be aesthetically pleasing to the end consumer and must be discarded during the production process and sent for material recycling. Cleaning agent systems established in the prior art for aluminum materials and aluminum cans in particular are often based on aqueous, acidic, fluoride-containing solutions, for which the fluoride content in the cleaning agent must then be precisely monitored during the throughput of the series of components to ensure a uniform glossy appearance, optionally by adding inhibitors. As an example of the procedural effort, reference can be made here to U.S. Pat. No. 5,565,076, which relates to a special design of a fluoride-sensitive glass electrode for the reliable determination of the fluoride content of acidic cleaning agent baths when treating aluminum cans.

Other alkaline cleaning agent systems, which are excellently suited to removing oil and grease residues from previous production steps, such as deep drawing, from aluminum surfaces, are often based on builder substances, such as borates and/or phosphates, that are problematic from a health or environmental hygiene perspective. In addition, the alkaline builders selected from phosphates, borates and/or silicates can cause surface defects during painting so that procedurally demanding monitoring of the composition of the cleaning agent bath is in turn required. Last but not least, even with alkaline cleaning agents, the pickling effect must be precisely set in order to achieve a consistent degree of gloss with short treatment times and high throughput rates, thus ensuring, for example in can production, that low waste and thus high economic efficiency and environmental compatibility are guaranteed.

From the above-mentioned requirements for a cleaning and degreasing step when producing semi-finished products and components made of the material aluminum and the prior art, it follows that the existing methods must be improved so that wet-chemical cleaning and degreasing of a plurality of semi-finished products or components is possible within short treatment times, as a result of which reliably high-gloss material surfaces are provided which, when coated with transparent lacquers, also meet high aesthetic standards and do not have any matting on the outer surfaces. In particular, a cleaning agent is to be provided that provides consistently good properties in terms of cleaning results and degree of gloss within a wide application window with regard to application temperature and duration without procedurally complex monitoring of bath parameters, even in high-throughput processes, such as can production. Furthermore, wet-chemical cleaning and degreasing is to be carried out using a composition that is as ecologically harmless as possible and the use of which, from an occupational hygiene point of view, does not pose any health risks for the workers responsible for carrying out and monitoring the cleaning process.

The present invention fulfills this requirement profile by establishing a method for cleaning surfaces made of the metal aluminum, in which the aluminum surface to be cleaned is brought into contact with an alkaline cleaning agent which has a pH of greater than 8.0 and contains, in addition to water,
a) at least one alkaline builder,
b) a total of at least 0.20 g/kg of aluminates dissolved in water, calculated as AlO₂, and
c) at least one surfactant.

The specified concentrations or quantities that characterize the alkaline cleaning agent within the context of the present invention each always refer to the overall composition of the alkaline cleaning agent, unless explicitly defined otherwise in the individual case.

For the purposes of the present invention, an alkaline builder refers to alkaline-reacting compounds or a mixture of such compounds, wherein at least one alkaline-reacting compound must be a component of the builder in a concentration of at least 1 mmol/kg, at which the equilibrium reaction that creates the alkalinity has a pK_{B} value ranging from 3.0-6.0. Well suited builders within the context of the present invention are therefore carbonates, borates, silicates and/or phosphates as well as mixtures of these compounds with hydroxides.

Within the context of the present invention, the alkaline builder is preferably selected from alkali metal carbonates and/or alkali metal carbonates, particularly preferably from alkali metal carbonates and particularly preferably from sodium carbonate.

In order to be able to effectively remove the drawing oils and greases commonly used in metalworking from the component surfaces to be cleaned, it is preferred for the cleaning agent to contain a total of at least 0.20 g/kg, particularly preferably a total of at least 0.30 g/kg, particularly preferably a total of at least 0.40 g/kg of alkali metal carbonates, calculated as CO₃. Cleaning and degreasing are also supported by pickling the aluminum basic substrate, but high pickling rates, even with short treatment times, are detrimental to surface gloss due to the increased surface roughness that is then significantly increased. In order to prevent the aluminum surfaces matting, the cleaning agents used according to the invention are preferably those whose total alkali metal carbonate content does not exceed 3.00 g/kg, particularly preferably does not exceed 2.00 g/kg, calculated as CO₃ in each case.

For similar reasons, for adequate cleaning and optionally removing drawing oils and greases, the pH of the alkaline cleaning agent must be greater than 8.0, preferably greater than 8.5. However, in order to be able to prevent over-pickling of the aluminum surfaces treated in the method according to the invention as far as possible without the use of inhibitors, it is preferred if the pH of the alkaline cleaning agent is not greater than 11.0, particularly preferably not greater than 10.5 and particularly preferably not greater than 10.0.

For sufficient pH stability and a consistent, but not excessive, pickling effect, it is preferred if the alkaline cleaning agent has a total alkalinity in points of at least 1.5, particularly preferably of at least 1.8, but preferably no total alkalinity exceeding 4.0 points, particularly preferably 3.0 points, very particularly preferably 2.4 points. The total alkalinity corresponds here to the consumption of 0.1 N hydrochloric acid in milliliters after titration of a sample volume of 10 ml of the cleaning agent, diluted with 50 ml of deionized water (κ<1 μScm⁻¹), to a pH of 3.6 at a temperature of 25° C.

For a moderate pickling effect during the method according to the invention, the free alkalinity of the alkaline cleaning agent in points is preferably not above 1.5, more preferably not above 1.0 and particularly preferably not above 0.8 points, but is preferably at least 0.2 points, particularly preferably 0.3 points. The free alkalinity corresponds here to the consumption of 0.1 N hydrochloric acid in milliliters after titration of a sample volume of 10 ml of the cleaning agent, diluted with 50 ml of deionized water (κ<1 μScm⁻¹), to a pH of 3.6 at a temperature of 25° C.

The presence of the aluminates dissolved in water, which are present as complex hydroxoaluminate ions, is essential for providing a glossy surface and maintaining glossiness during the cleaning process according to the method of the invention. All water-soluble aluminates are suitable as a source of the aluminates dissolved in water, preferably alkali metal aluminates, for example sodium aluminate and/or potassium aluminate, but particularly preferably sodium aluminate.

The aluminates render the cleaning and degreasing process in the alkaline medium very efficient and without any loss of gloss properties, since over-pickling of the aluminum substrate is prevented in the presence of the aluminates. For this purpose, a total content of at least 0.20 g/kg of aluminates dissolved in water, preferably a total content of at least 0.40 g/kg, particularly preferably a total content of at least 0.60 g/kg is required, in each case calculated as AlO₂. Significantly higher contents of aluminates can be achieved in the cleaning agent without loss of performance, in particular without loss of glossiness, but for reasons of economy, the content of aluminates dissolved in water should be limited and the alkaline cleaning agent preferably contains less than 4.00 g/kg, particularly preferably a total of less than 3.00 g/kg, particularly preferably less than 2.00 g/kg of aluminates dissolved in water, calculated as AlO₂. Overall, there is a broad application window with regard to the content of aluminates dissolved in water, which opens up a high degree of procedural flexibility.

The presence of at least one surfactant is necessary for effective cleaning and degreasing performance. In principle, all surface-active substances known in the prior art that are capable of emulsifying non-polar components in a continuous aqueous phase are suitable. These include anionic surfactants, such as the fatty acids mentioned above, but in particular also non-ionic surfactants. In a preferred embodiment of the method according to the invention, the alkaline cleaning agent therefore contains at least one non-ionic surfactant that has an HLB value above 10.0, preferably above 11.0, particularly preferably above 12.0. Within the context of the present invention, the HLB value is an empirical quantity and is calculated as follows:

$$HLB = 20 \cdot ( 1 - {M}_{L} / M )$$

where M_{L}: molar mass of the lipophilic group of the non-ionic surfactant;
M: molar mass of the non-ionic surfactant.

Preferred nonionic surfactants having an HLB value greater than 10.0 are selected from alkyl benzyl alkoxylates having no more than 12 carbon atoms in the alkyl group, which in turn is preferably saturated, wherein the alkyl benzyl alkoxylates have at least 6, but no more than 14, alkoxy units.

Equally suitable, and to this extent equally preferred, are nonionic surfactants having an HLB value greater than 10.0, which are selected from fatty alcohol alkoxylates that have at least 8, but no more than 16, carbon atoms in the alkyl group, which is preferably saturated and particularly preferably saturated and unbranched, and have at least 10, but no more than 30, alkoxy units, wherein the alkoxy units are preferably each selected from ethoxy and/or propoxy units.

At high throughput rates of semi-finished products and components made of aluminum or during prolonged operation of a cleaning bath according to the method according to the invention, the precipitation of aluminum salts can become problematic due to the increased introduction of aluminum ions. The microcrystalline deposits that occur together with the precipitations on the semi-finished products and components impair the gloss properties of the aluminum surfaces and also represent surface defects with potentially insufficient adhesion to subsequently applied paint systems. To prevent this, the alkaline cleaning agent preferably also contains organic complexing agents, which in turn are preferably selected from α-hydroxycarboxylic acids, particularly preferably selected from α-hydroxycarboxylic acids with no more than three carboxyl groups, very particularly preferably from sugar acids, particularly preferably aldonic acids and aldaric acids, and particularly preferably from citric acid and/or tartaric acid. For sufficient metering, it is generally advantageous if the molar ratio of organic complexing agents to aluminates in the cleaning agent ranges from 1:1 to 1:10, particularly preferably from 1:2 to 1:8.

One advantage of the alkaline cleaning agent used in the method according to the invention is that it can be formulated without fluoride and without the addition of inhibitors. Furthermore, builder substances, such as phosphates and/or borates, that are potentially harmful to health and the environment can be avoided.

According to the invention, methods are therefore preferred in which the alkaline cleaning agent contains a total of less than 100 mg/kg, particularly preferably less than 10 mg/kg, particularly preferably less than 1 mg/kg of phosphates dissolved in water, calculated as PO₄, or borates dissolved in water, calculated as BO₃, or silicates dissolved in water, calculated as SiO₄.

Also preferred according to the invention are methods in which the alkaline cleaning agent contains a total of less than 100 mg/kg, particularly preferably less than 10 mg/kg, particularly preferably less than 1 mg/kg of fluorides dissolved in water, calculated as the total fluoride content. The total proportion of fluorides (total fluoride content) is determined in a TISAB-buffered aliquot part of the alkaline cleaning agent using a fluoride-sensitive electrode at 20° C. (TISAB: “total ionic strength adjustment buffer”), the mixture ratio of buffer volume to the volume of the aliquot part of the cleaning agent being 1:1. The TISAB buffer is prepared by dissolving 58 g NaCl, 1 g sodium citrate and 50 ml glacial acetic acid in 500 ml deionized water (κ<1 μScm⁻¹) and setting a pH of 5.3 using 5 N NaOH and filling to a total volume of 1000 ml, again with deionized water (κ<1 μScm⁻¹).

Also preferred is the absence of corrosion inhibitors that are otherwise common for aluminum and therefore that the alkaline cleaning agent contains a total of less than 100 mg/kg, preferably less than 10 mg/kg, particularly preferably less than 1 mg/kg of benzoic acid and benzoates dissolved in water, calculated as C₇H₆O₂ or of organic compounds dissolved in water with at least one nitrogen-containing heterocyclic compound, calculated as N₃.

In the method according to the invention, contact with the alkaline aqueous cleaning agent can be made using any of the application methods established in the prior art, wherein immersion, flooding, spraying, and misting of the aluminum surfaces, in particular immersion and spraying, the latter application being preferred and established in high-throughput processes such as can manufacturing. The contact times preferably range from 5 to 180 seconds, usually and therefore particularly preferably being less than 60 seconds, particularly preferably being 10 to 30 seconds.

The temperature range in which contact with the alkaline aqueous cleaning agent takes place and cleaning is carried out particularly effectively is 30 to 65° C., particularly preferably 40 to 60° C., particularly preferably 45 to 55° C., in each case as the temperature of the cleaning agent when contact is made.

The surfaces of the metal aluminum treated in the cleaning method according to the invention are preferably the surfaces of those semi-finished products and components which are made of the material aluminum or are aluminum-plated. Both aluminum platings and aluminum materials that form surfaces of the metal aluminum within the meaning of the present invention consist of more than 50 at. %, preferably more than 80 at. %, particularly preferably more than 90 at. % of the metal aluminum and thus aluminum alloys can also be cleaned in the method according to the invention. Other alloy components can be selected, for example, from manganese, magnesium, iron, copper, zinc, chromium, zirconium and/or silicon. A particularly preferred aluminum material that can be cleaned very reliably in the method according to the invention is the 3xxx alloy series, in particular the 3004 alloy, which is used specifically for the production of beverage cans.

In principle, all semi-finished products and components made from the aforementioned materials can be cleaned and degreased in the method according to the invention. Particularly worth mentioning here are flat products, such as sheets and semi-finished products formed therefrom, for example by deep drawing, such as cans that are open on one side. However, as mentioned at the outset, the method is particularly suitable for cleaning and degreasing during the series production of a plurality of semi-finished products and components at a high throughput rate and therefore the present invention focuses on cleaning and degreasing can cylinders for the production of beverage or aerosol cans, which thus represents the correspondingly preferred application example of the method according to the invention.

In the method according to the invention, those surfaces made of the metal aluminum which represent the surfaces of a plurality of can cylinders made of aluminum and its alloys are therefore particularly preferably cleaned and degreased.

In a second aspect, the present invention relates to a composition which is particularly suitable for use as an aqueous alkaline cleaning agent in a method according to the invention. This composition according to the invention is an alkaline cleaning agent for aluminum surfaces which has a pH of greater than 8.0 and preferably no greater than 11.0 and contains, in addition to water,
a) at least 0.20 g/kg, but preferably no more than 3.00 g/kg of alkali metal carbonates calculated as CO₃,
b) at least 0.20 g/kg, but preferably less than 4.00 g/kg of aluminates dissolved in water, preferably sodium aluminate, calculated as AlO₂,
c) at least one nonionic surfactant with an HLB value greater than 10.0, and
d) at least one organic complexing agent, which is preferably selected from α-hydroxycarboxylic acids, particularly preferably selected from α-hydroxycarboxylic acids with no more than three carboxyl groups, very particularly preferably selected from gluconic acid and/or citric acid.

Further preferred embodiments of the alkaline cleaning agent can be carried out analogously to those described with regard to the alkaline cleaning agent used in the method according to the invention.

### EXAMPLES

To illustrate the cleaning and degreasing performance of alkaline cleaning agents according to the invention, beverage cans made of Al3004 that were open on one side were cleaned using different formulations by spraying. The cleaning agents were applied by spraying at 1.0 bar. After spraying on the cleaning agent, cleaning agent residues were removed from the semi-finished products by briefly immersing them in deionized water (κ<1 μScm⁻¹) and the degree of gloss was determined after removing and blowing off the surfaces. To determine the degree of gloss, the reflectance of each substrate surface was measured and compared with the reflectance of a surface of each semi-finished product degreased using a mixture of n-hexane/ethanol (1:1 by volume). The corresponding results are shown in Table 1. The application solution according to the invention contains the following components as a 1 wt. % solution of the cleaning agent concentrate (see B1, Table 1):

| | |
|---|---|
| Sodium aluminate | 0.90 g/kg |
| Na₂CO₃ | 0.47 g/kg |
| Non-ionic surfactants | 0.26 g/kg |
| (HLB value 10-12) | |
| Sodium gluconate | 0.26 g/kg |
| Citric acid | 0.30 g/kg |

TABLE 1

| | Amount in | | Duration | T | Degree |
|---|---|---|---|---|---|
| | wt. % | pH | in s | in ° C. | of gloss^{#} |
| B1 | 1.0 | 9.6 | 40 | 60 | 95 |
| B1 | 1.0 | 9.6 | 180 | 60 | 94 |
| B2 | 1.5 | 9.6 | 40 | 60 | 94 |
| B2 | 1.5 | 9.8 | 180 | 55 | 95 |
| VB1 | 1.5 | 9.8 | 40 | 60 | 70 |
| VB1 | 1.5 | 9.8 | 180 | 60 | 20 |
| VB2 | 1.5 | 2.1 | 40 | 60 | 98 |
| VB2 | 1.5 | 2.1 | 180 | 60 | 50 |

^{#}determined at an angle of 60° with Picogloss Model 503 from Erichsen
B1/B2 alkaline cleaning agents according to the invention based on the same concentrate
VB1 Comparative Example 1: commercial alkaline cleaning agent based on NaOH/borate (Bonderite ® C-AK 60036 from Henkel AG)
VB2 Comparative Example 2: commercial fluoride-containing cleaning agent based on H₂SO₄/HF (Bonderite ® C-IC 740 E from Henkel AG).

1. A method for cleaning surfaces of the metal aluminum, in which an aluminum surface to be cleaned is brought into contact with an alkaline cleaning agent which has a pH of greater than 8.0 and contains, in addition to water,
a) at least one alkaline builder,
b) a total of at least 0.20 g/kg of aluminates dissolved in water, calculated as AlO₂, and
c) at least one surfactant.

2. The method according to claim 1, wherein the alkaline builder of the cleaning agent is selected from alkali metal hydroxides and/or alkali metal carbonates.

3. The method according to claim 2, wherein the alkaline cleaning agent contains a total of at least 0.20 g/kg and no more than 3.00 g/kg, of alkali metal carbonates, calculated as CO₃.

4. The method according to claim 1, wherein the pH of the cleaning agent is greater than 8.5, but no greater than 11.0.

5. The method according to claim 1, wherein the alkaline cleaning agent contains alkali metal aluminates as a source of the aluminates dissolved in water.

6. The method according to claim 1, wherein the alkaline cleaning agent contains a total of at least 0.40 g/kg but less than 4.00 g/kg, of aluminates dissolved in water, calculated as AlO₂.

7. The method according to claim 1, wherein the at least one surfactant in the alkaline cleaning agent is selected from nonionic surfactants comprising alkyl benzyl alkoxylates that have no more than 12 carbon atoms in the alkyl group, and have at least 6 but no more than 14 alkoxy units.

8. The method according to claim 1, wherein the alkaline cleaning agent additionally contains organic complexing agents, which are selected from α-hydroxycarboxylic acids with no more than three carboxyl groups.

9. The method according to claim 8, wherein the molar ratio of organic complexing agents to aluminates in the alkaline cleaning agent ranges from 1:1 to 1:10.

10. The method according to claim 9, wherein the at least one surfactant in the alkaline cleaning agent is selected from fatty alcohol alkoxylates that have saturated alkyl groups comprising at least 8 but no more than 16 carbon atoms in the alkyl groups, and have at least 10 but no more than 30 alkoxy units, the alkoxy units each being selected from ethoxy and/or propoxy units.

11. The method according to claim 1, wherein the alkaline cleaning agent additionally contains organic complexing agents, which are selected from gluconic acid, citric acid, tartaric acid and salts thereof.

12. The method according to claim 1, wherein the alkaline cleaning agent contains a total of less than 100 mg/kg of phosphates dissolved in water, calculated as PO₄.

13. The method according to claim 1, wherein the cleaning agent contains a total of less than 100 mg/kg of borates dissolved in water, calculated as BO₃.

14. The method according to claim 1, wherein the alkaline cleaning agent contains a total of less than 100 mg/kg of benzoic acid and benzoates dissolved in water, calculated as C₇H₆O₂.

15. The method according to claim 1, wherein the alkaline cleaning agent contains a total of less than 100 mg/kg of organic compounds dissolved in water that have at least one nitrogen-containing heterocyclic compound, calculated as N₃.

16. The method according to claim 1 for cleaning and degreasing surfaces of the metal aluminum, which represent the surfaces of a plurality of can cylinders made of aluminum.

17. An alkaline cleaning agent for aluminum surfaces, which has a pH of greater than 8.0 and containing, in addition to water,
a) at least 0.20 g/kg of alkali metal carbonates calculated as CO₃,
b) at least 0.20 g/kg of aluminates dissolved in water, calculated as AlO₂,
c) at least one nonionic surfactant with an HLB value greater than 10.0, and
d) at least one organic complexing agent, which is selected from α-hydroxycarboxylic acids.
